(19) United States
(12) Patent Application Publication
(10) Pub. No.: US 2024/0299951 A1
(43) Pub. Date: Sep. 12, 2024

(54) REDUCED VIBRATION MOBILE MATERIAL PROCESSING PLANT

(71) Applicant: Terex USA, LLC, Norwalk, CT (US)

(72) Inventors: Rex Mikle CARTER, Newcastle, OK (US); Edwin J. SAUSER, Monticello, IA (US); Alexander Evan ROSS, Washington, IA (US)

(21) Appl. No.: 18/607,937

(22) Filed: Mar. 18, 2024

Related U.S. Application Data
(62) Division of application No. 17/097,021, filed on Nov. 13, 2020, now Pat. No. 11,958,055.
(60) Provisional application No. 62/935,313, filed on Nov. 14, 2019.

(51) Int. Cl. B02C 21/02; B02C 2/00; B60S 9/12; B66F 3/46; E01C 19/05

(52) U.S. Cl. CPC B02C 21/02; B60S 9/12; B66F 3/46; E01C 19/05; B02C 2/00

(57) ABSTRACT

A mobile cone plant with canted run-on jacks for limited vibration of the chassis without a need for clamping or extremely tight tolerances in telescopic jack parts.

### CROSS REFERENCE TO RELATED APPLICATIONS

The present application is a divisional application of the non-provisional application having Ser. No. 17/097,021 filed on Nov. 13, 2020, which application claims the benefit of the filing date of provisional patent application having Ser. No. 62/935,313 filed on Nov. 14, 2019 by the same inventors entitled Canted Hydraulic Leg Design, which applications are incorporated herein in its entirety by this reference.

### FIELD OF THE INVENTION

The present invention generally relates to systems and methods for mobile rock crushing and/or screening plants.

### BACKGROUND OF THE INVENTION

This invention relates to mobile rock crushing and/or screening plants. A portable rock crushing and/or screening processing plant is either a single crusher or screen or a collection of several units, each performing various material processing functions to prepare aggregate materials for use for, but not limited to, concrete and asphalt products. The various units can perform various stages of crushing, screening, conveying, and washing of aggregate and recycle materials. Portability is achieved by positioning the plants on towable or haulable modules, so that the plant can service multiple locations where processed materials can be produced.

Many plants have utilized with run-on and/or leveling jacks to level the crusher or screen and/or reduce vibration of the plant.

While such systems have enjoyed some commercial success in the industry, they have drawbacks.

Traditionally, these jacks will wiggle due to clearances between telescoping portions of the jack. One method of reducing the vibration in such systems was to provide some type of structure to clamp together or otherwise limit the vibration induced relative motion of the telescoping jack portions after the jack length has been adjusted to a desired configuration. These approaches require some extra structure, such as pins and pin receiving members, clamps, etc. to achieve this result. Moreover, it requires time to make the required actions to clamp or otherwise limit the motion.

Consequently, there is a need for improvement in portable material processing equipment which eliminates or greatly reduces vibration and extra labor required each time a mobile plant is adjusted, reconfigured and/or deployed in a new location.

### SUMMARY OF THE INVENTION

More specifically, an object of the invention is to provide efficient mobile material processing plants.

It is a feature of the present invention to include a plurality of canted run-on and/or leveling jacks.

It is another feature of the present invention to include a plurality of rubber isolation mounts for the material processing plant.

It is an advantage of the present invention to decrease the vibration of the plant without substantially adversely affecting the cost and efficiency of use of the system.

It is yet another feature to have a processing plant which is free of any structure which is configured for reducing vibration induced relative movement between top and bottom portions of run-on telescopic jacks.

The present invention includes the above-described features and achieves the aforementioned objects and advantages.

Accordingly, the present invention is a mobile plant comprising:
a chassis;
a group of dual wheels coupled to the chassis;
a crusher disposed on the chassis; and
a plurality of jacks, each of which is not oriented substantially perpendicular with respect to a longitudinal axis of said chassis.

Additionally, the present invention comprises the method of deploying a mobile cone plant comprising the steps of:
providing a semi-trailer, having a group of rear tandem dual wheels;
providing a cone crusher on said semi-trailer;
providing a first front telescoping jack (120) with a first front telescoping jack longitudinal axis and with a first front telescoping jack top portion (221) and a first front telescoping jack bottom portion (220);
providing a second front telescoping jack (122) with a second front telescoping jack longitudinal axis and with a second front telescoping jack top portion and a second front telescoping jack bottom portion;
providing a first rear telescoping jack with a first rear telescoping jack longitudinal axis and with a first rear telescoping jack top portion and a first rear telescoping jack bottom portion;
providing a second rear telescoping jack with a second rear telescoping jack longitudinal axis and with a second rear telescoping jack top portion and a second rear telescoping jack bottom portion;
adjusting a length characteristic of said first front telescopic jack so as to level said semi-trailer;
after adjusting said length characteristic making an adjustment to one of said first rear telescoping jack and said second rear telescoping jack so as to reduce vibration induced relative motion therein, without making said semi-trailer not level; and
operating said cone crusher without using pins or clamps to reduce relative motions.

### BRIEF DESCRIPTION OF THE DRAWINGS

In the following description of the drawings, like reference numerals are employed to indicate like parts, in the various views:

FIG. 1 is a side view of a system of the present invention.

FIG. 2 is a front end view of a portion of FIG. 1.

FIG. 3 is a perspective view of the system of FIGS. 1 and 2 with the canted jacks being disposed in non-transport configuration.

### DETAILED DESCRIPTION OF THE DRAWINGS

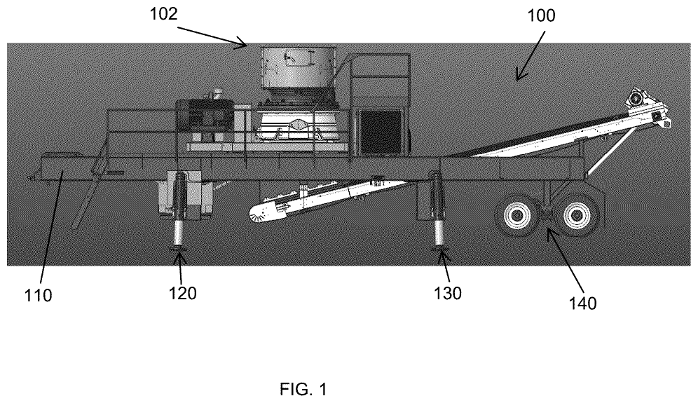

Now referring to the drawings where like numerals refer to like matter throughout, and more specifically to FIG. 1, there is shown a vibration reduced material processing plant 100 having a cone crusher 102 , however other high vibration material processing plants could be substituted, such as vibrating screens, trommels, grizzly bars, and other suitable plants, supported in part by a first frame support member 110 which is shown with first front telescoping jack 120 having a first front telescoping jack longitudinal axis and first rear telescoping jack 130 having a first rear telescoping jack longitudinal axis. Jacks 120 and 130 are shown as hydraulic jacks, but non-hydraulic mechanical jacks might be preferred in some applications. Since vibration reduced material processing plant 100 is mobile, there is also shown a first side rear tandem dual wheel group 140. The first frame support member 110 is assumed to be horizontal and the first front telescoping jack 120 and the first rear telescoping jack 130 are not vertical with respect to the first frame support member 110. The points where first front telescoping jack 120 and first rear telescoping jack 130 are coupled to the first frame support member 110 are closer to each other than the points where first front telescoping jack 120 and first rear telescoping jack 130 contact the ground. In other words, first front telescoping jack longitudinal axis is upwardly angled toward the cone crusher 102 and the first rear telescoping jack longitudinal axis is also upwardly angled toward the cone crusher 102 and each is closer to the other as they go further upward as shown in this FIG. 1.

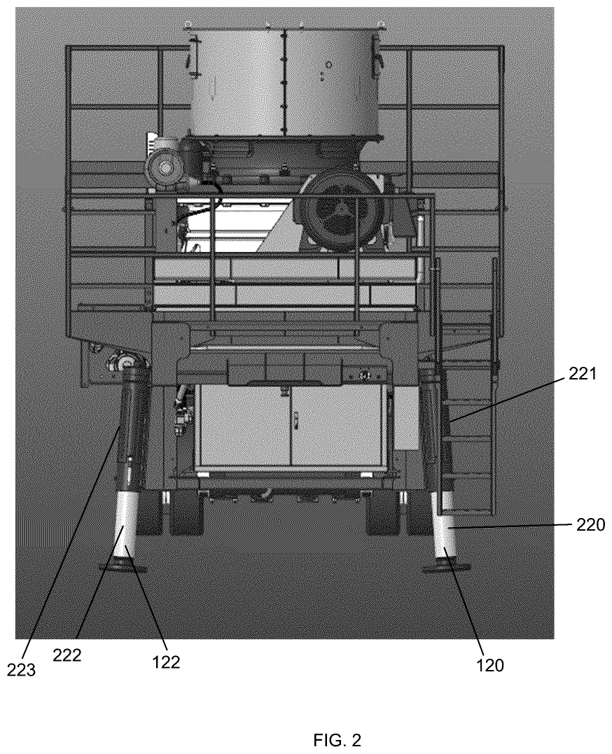

Now referring to FIG. 2, there is shown a front end view of the vibration reduced material processing plant 100 of FIG. 1 where the first front telescoping jack 120 is shown having a first front telescoping jack bottom portion 220 and a first front telescoping jack top portion 221. There is also shown second front telescoping jack 122 which has a second front telescoping jack bottom portion 222 and a second front telescoping jack top portion 223. This front end view clearly shows the first front telescoping jack longitudinal axis being upwardly inclined toward the cone crusher 102. Similarly, the second front telescoping jack longitudinal axis is upwardly inclined toward the cone crusher 102 and each axis is closer to the other as they go further upward, as shown in this FIG. 2. In other words, the top portion of each second front telescoping jack 122 and first front telescoping jack 120 are closer to each other than their bottom portions are.

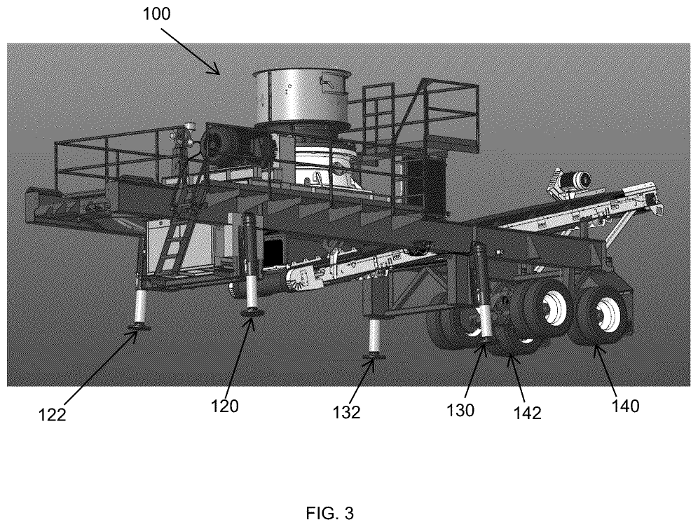

Now referring to FIG. 3, there is shown a perspective view of the vibration reduced material processing plant 100, which includes second rear telescoping jack 132. There is also shown a first side rear tandem dual wheel group 140 and a second side rear tandem dual wheel group 142. In this FIG. 3, it can be seen that the uppermost top portions of any two jacks are closer to each other than are their lowermost bottom portions. In some embodiments, the longitudinal axes of the jacks might be directed toward an apex centrally located above a central portion of the cone crusher 102.

In operation, the cone crusher 102 in a preferred embodiment may be a style of crusher that is not dynamically balanced about a vertical axis through the crusher. Cone crusher 102 is preferably mounted on rubber isolation mounts. Because of the unbalanced crusher, there is a resulting lateral force transmitted to the chassis including the first frame support member 110. During operation, this lateral force is rotating radially around the vertical axis through the cone crusher 102 center so the jacks 120, 122, 130 and 132 all experience a lateral force in all directions.

The jacks, with their canted or upwardly and inwardly angled axes, apply opposing lateral force which offsets some, if not all, of the lateral force transmitted through the rubber isolation mounts from the unbalanced crusher. The jacks are all slightly tilted toward the center so they can resist the forces in both side to side and also in end to end direction. With enough of this tilt, the lateral force from the leaning jacks is sufficient to prevent the telescoping portions of each of the jacks from moving relative to each other so that the normal fixes of having very tight clearances in the top and bottom portions of the jacks or clamping structures are not needed to hold the chassis from moving significantly.

The figures show a plurality of four jacks, which may be preferred but any number of a plurality of jacks will provide at least some of the benefits as described herein.

It is believed that when these teachings are combined with the known prior art by a person skilled in the art of mobile rock crushing and screening operations and equipment manufacture, many of the beneficial aspects and the precise approaches to achieve those benefits will become apparent.

It will be understood that certain features and sub-combinations are of utility and may be employed without reference to other features and sub-combinations. This is contemplated by and is within the scope of the claims.

Since many possible embodiments may be made of the invention without departing from the scope thereof, it is understood that all matter herein set forth or shown in the accompanying drawings is to be interpreted as illustrative and not in a limiting sense.

We claim:

1. A mobile plant comprising:
a chassis;
a group of dual wheels coupled to the chassis;
a crusher disposed on the chassis; and
a plurality of jacks, each of which is not oriented substantially perpendicular with respect to a longitudinal axis of said chassis.

2. The mobile plant of claim 1 wherein one of said plurality of jacks is disposed between another of said plurality of jacks and said group of dual wheels.

3. The mobile plant of claim 2 wherein one of said plurality of jacks is free of any structure configured to reduce an internal vibration induced relative motion between portions thereof.

4. The mobile plant of claim 1 wherein each of said plurality of jacks is a telescopic jack.

5. The mobile plant of claim 4 wherein each of said plurality of jacks is a hydraulic jack.

6. The mobile plant of claim 4 wherein said internal vibration induced relative motion between portions thereof is between nested portions of said telescopic jack.

7. The mobile plant of claim 2 is free of any pins or clamps configured to reduce internal vibration induced relative motion in each of said plurality of jacks.

8. A mobile plant comprising:
a chassis;
a group of wheels coupled to the chassis,
a crusher disposed on the chassis; and
a plurality of jacks, each of which is not oriented perpendicular with respect to a longitudinal axis of said chassis.

9. The mobile plant of claim 1 wherein one of said plurality of jacks is disposed between another of said plurality of jacks and said group of dual wheels.

10. The mobile plant of claim 2 wherein one of said plurality of jacks is free of any structure configured to reduce an internal vibration induced relative motion between portions thereof.

11. A mobile plant comprising:
a chassis;
a group of tandem dual wheels coupled to the chassis;
a cone crusher disposed on the chassis; and
a plurality of jacks, each of which is not oriented substantially perpendicular with respect to a longitudinal axis of said chassis.

12. The mobile cone plant of claim 11 wherein one of said plurality of jacks is disposed between another of said plurality of jacks and said group of tandem dual wheels.

13. The mobile cone plant of claim 12 wherein one of said plurality of jacks is free of any structure configured to reduce an internal vibration induced relative motion between portions thereof.

14. The mobile cone plant of claim 11 wherein each of said plurality of jacks is a telescopic jack.

15. The mobile cone plant of claim 14 wherein each of said plurality of jacks is a hydraulic jack.

16. The mobile cone plant of claim 14 wherein said internal vibration induced relative motion between portions thereof is between nested portions of said telescopic jack.

17. The mobile cone plant of claim 12 is free of any pins or clamps configured to reduce internal vibration induced relative motion in each of said plurality of jacks.

18. A method of deploying a mobile cone plant comprising the steps of:
providing a semi-trailer, having a group of rear tandem dual wheels;
providing a cone crusher on said semi-trailer;
providing a first front telescoping jack (120) with a first front telescoping jack longitudinal axis and with a first front telescoping jack top portion (221) and a first front telescoping jack bottom portion (220);
providing a second front telescoping jack (122) with a second front telescoping jack longitudinal axis and with a second front telescoping jack top portion and a second front telescoping jack bottom portion;
providing a first rear telescoping jack with a first rear telescoping jack longitudinal axis and with a first rear telescoping jack top portion and a first rear telescoping jack bottom portion;
providing a second rear telescoping jack with a second rear telescoping jack longitudinal axis and with a second rear telescoping jack top portion and a second rear telescoping jack bottom portion;
adjusting a length characteristic of said first front telescopic jack so as to level said semi-trailer;
after adjusting said length characteristic making an adjustment to one of said first rear telescoping jack and said second rear telescoping jack so as to reduce vibration induced relative motion therein, without making said semi-trailer not level; and
operating said cone crusher without using pins or clamps to reduce relative motions.
